(19) United States
(12) Patent Application Publication
(10) Pub. No.: US 2008/0134282 A1
(43) Pub. Date: Jun. 5, 2008

(54) SYSTEM AND METHOD FOR FILTERING OFFENSIVE INFORMATION CONTENT IN COMMUNICATION SYSTEMS

(75) Inventors: Sharon FRIDMAN, Chiswick (GB); Ben Volach, Richmond (GB)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/844,989

(22) Filed: Aug. 24, 2007

Related U.S. Application Data
(60) Provisional application No. 60/839,703, filed on Aug. 24, 2006.
(60) Provisional application No. 60/839,705, filed on Aug. 24, 2006.

(51) Int. Cl. G06F 21/00

(52) U.S. Cl. 726/1

(57) ABSTRACT

The present invention is directed to a system and method for filtering offensive information content in communication environments. The system includes an offensive information filtering server module in communication with a plurality of user communication devices. The offensive information filtering server module includes an offensive content detection module. The offensive content detection module is configured to detect offensive information content in communications between the user communication devices. The offensive information filtering server module includes an offensive content filtering module in communication with the offensive content detection module. The offensive content filtering module is configured to filter the offensive information content detected in the communications by the offensive content detection module.

The present application claims priority under 35 U.S.C. § 119(e) to U.S. Provisional Application Nos. 60/839,703, filed Aug. 24, 2006, and 60/839,705, filed Aug. 24, 2006, the entire contents of each which are hereby incorporated by reference herein.

### BACKGROUND

1. Field of the Invention

The present invention relates to communication systems. More particularly, the present invention relates to a system and method for filtering offensive information content in communication systems.

2. Background Information

Communication environments can provide communication messaging services (e.g., instant messaging (IM), e-mail, or the like) through which users can exchange messages and other information. For example, presence services can be used in telecommunications, internet, and by other communication and service providers to capture the ability and willingness of users to communicate. In particular, a rich presence environment can allow a user to define presence information that may be text- and/or graphical-based. Communications services can use rich and other multimedia content to enhance the communication experience of the user. For example, conventional messaging systems can allow different suitable forms of media to be communicated between users, including various types of rich media, such as, for example, pictures, graphics, presentations, audio and/or video clips, flash, animations, game commands, and the like.

Such communication services can provide content filtering to protect users from offensive content. For example, a conventional “black list” can prevent IM users from exchanging textual messages with racist, defamatory, indecent, or other offensive wording in general, including, in particular, pornographic or abusive language or other content. The offensive wording can be removed or modified by such a content filtering system.

Such filtering mechanisms are becoming increasingly important for communication services for purposes of parental control and child abuse prevention, as well as to address regulatory issues. However, presence content is not currently protected by existing content-filtering mechanisms. Rather, conventional presence services provide authorization and privacy rules that allow blocking or allowing users to view information, but do not address presence information as potentially offensive content. In addition, there are currently no available offensive content filtering mechanisms in mobile environments and/or mobile telecommunications for rich media delivery.

### SUMMARY OF THE INVENTION

A system and method are disclosed for filtering offensive information content in communication systems. In accordance with exemplary embodiments of the present invention, according to a first aspect of the present invention, a system for filtering information in a mobile communication system includes an offensive information filtering server module in communication with a plurality of user communication modules. The offensive information filtering server module includes an offensive content detection module. The offensive content detection module is configured to detect offensive information content in mobile communications between the user communication modules. The offensive information filtering server module includes an offensive content filtering module in communication with the offensive content detection module. The offensive content filtering module is configured to filter the offensive information content detected in the mobile communications by the offensive content detection module.

According to the first aspect, the offensive information filtering server module can include an offensive content filtering policy management module. The offensive content filtering policy management module can be configured to manage filtering policy used by the offensive content filtering module to filter the offensive information content detected in the mobile communications. In particular, the offensive content filtering module can be configured to analyze the filtering policy associated with the user communication modules to determine whether offensive content filtering is enabled for the mobile communications. The offensive content filtering module can be configured to filter the offensive information content in the mobile communications when it is determined that offensive content filtering is enabled. The offensive content filtering policy management module can also be configured to manage offensive content filtering preferences of users.

According to the first aspect, the offensive information filtering server module can include an information storage module. The information storage module can be configured to store offensive content filtering information. For example, the information storage module can be configured to store a log of offensive information content. The offensive information filtering server module can include a communication module. The communication module can be configured to communicate information with user communication modules. The offensive content filtering module can be configured to remove the offensive information content from the mobile communications. The offensive content filtering module can be configured to block the mobile communications that include offensive information content. The offensive content filtering module can be configured to modify the offensive information content in the mobile communications to generate non-offensive information content. The system can include a system administration module in communication with the offensive information filtering server module. The system administration module can be configured to administer the offensive information filtering server module. According to an exemplary embodiment of the first aspect, the mobile communications can comprise, for example, rich media content, such as multimedia or other like information. Additionally or alternatively, the mobile communications can comprise, for example, service information, such as presence or other like information.

According to a second aspect of the present invention, a system for filtering presence information includes an offensive presence information filtering server in communication with a plurality of user communication devices. The offensive presence information filtering server includes an offensive presence content recognition module. The offensive presence content recognition module is configured to recognize offensive presence information content in communications between user communication devices. The offensive presence information filtering server also includes an offensive presence content filtering module in communication with the offensive presence content recognition module. The offensive presence content filtering module is configured to filter the offensive presence information content detected in the communications by the offensive presence content recognition module.

According to the second aspect, the offensive presence information filtering server can include an offensive presence content filtering policy management module. The offensive presence content filtering policy management module can be configured to manage filtering policy used by the offensive presence content filtering module to filter the offensive presence information content detected in the communications. In particular, the offensive presence content filtering module can be configured to analyze the filtering policy associated with the user communication devices to determine whether offensive presence content filtering is enabled for the communications. The offensive presence content filtering module can be configured to filter the offensive presence information content in the communications when it is determined that offensive presence content filtering is enabled. The offensive presence content filtering policy management module can also be configured to manage offensive presence content filtering preferences of users.

According to the second aspect, the offensive presence information filtering server can include an information repository module. The information repository module can be configured to store offensive presence content filtering information. For example, the information repository module can be configured to store a log of offensive presence information content. The offensive presence information filtering server can include a communication module. The communication module can be configured to communicate information with user communication devices. The offensive presence content filtering module can be configured to remove the offensive presence information content from the communications. The offensive presence content filtering module can be configured to block the communications that include offensive presence information content. The offensive presence content filtering module can be configured to modify the offensive presence information content in the communications to generate non-offensive presence information content. The system can include a system administration module in communication with the offensive presence information filtering server. The system administration module can be configured to administer the offensive presence information filtering server.

According to a third aspect of the present invention, an apparatus for filtering offensive information content in a mobile communication environment includes a user communication device. The user communication device includes offensive information filtering client structure. The offensive information filtering client structure includes offensive content detection structure. The offensive content detection structure is adapted to detect offensive information content in mobile communications between user communication devices. The offensive information filtering client structure includes offensive content filtering structure in communication with the offensive content detection structure. The offensive content filtering structure is adapted to filter the offensive information content detected in the mobile communications by the offensive content detection structure.

According to the third aspect, the offensive information filtering client structure can include offensive content filtering policy management structure. The offensive content filtering policy management structure can be adapted to manage filtering policy used by the offensive content filtering structure to filter the offensive information content detected in the mobile communications. The offensive content filtering structure can be adapted to analyze the filtering policy associated with the user communication devices to determine whether offensive content filtering is enabled for the mobile communications. The offensive content filtering structure can be adapted to filter the offensive information content in the mobile communications when it is determined that offensive content filtering is enabled. The offensive content filtering policy management structure can also be adapted to manage offensive content filtering preferences of users.

According to the third aspect, the offensive information filtering client structure can include information storage structure. The information storage structure can be adapted to store offensive content filtering information. The information storage structure can be adapted to store a log of offensive information content. The offensive information filtering client structure can include communication structure. The communication structure can be adapted to communicate information with user communication devices. The offensive content filtering structure can be adapted to remove the offensive information content from the mobile communications. The offensive content filtering structure can be adapted to block the mobile communications that include offensive information content. The offensive content filtering structure can be adapted to modify the offensive information content in the mobile communications to generate non-offensive information content. A system administration server can be in communication with the offensive information filtering client structure. The system administration server can be adapted to administer the offensive information filtering client structure. According to an exemplary embodiment of the third aspect, the mobile communications can comprise, for example, rich media content, such as multimedia or other like information. Additionally or alternatively, the mobile communications can comprise, for example, service information, such as presence or other like information.

According to a fourth aspect of the present invention, a method of filtering offensive information content in a communication environment includes the steps of: communicating a mobile communication incorporating offensive information content between user communication devices; detecting the offensive information content in the mobile communication; and filtering the offensive information content detected in the mobile communication.

According to the fourth aspect, the method can include the step of generating the mobile communication incorporating the offensive information content. The method can also include the step of managing offensive content filtering policy associated with each of the user communication devices. The method can include one or more of the steps of: accessing offensive content filtering policy associated with the user communication devices; and analyzing the offensive content filtering policy associated with the user communication devices to determine whether offensive content filtering is enabled. The filtering step can be performed when it is determined that offensive content filtering is enabled. For example, the filtering step can include one or more of the steps of: removing the offensive information content from the mobile communication; blocking the mobile communication when offensive information content is detected; and modifying the offensive information content in the mobile communication to generate non-offensive information content. The method can further include the step of communicating the mobile communication with non-offensive information content after the filtering step. The method can include one or more of the steps of: managing offensive content filtering preferences of users; storing offensive content filtering information; and storing a log of offensive information content. According to an exemplary embodiment of the fourth aspect, the mobile communication can comprise, for example, rich media content, such as multimedia or other like information. Additionally or alternatively, the mobile communication can comprise, for example, service information, such as presence or other like information.

According to a fifth aspect of the present invention, a system for filtering information in a mobile communication system includes means for enabling offensive information filtering in communication with a plurality of user communication modules. The offensive information filtering enabling means includes means for detecting offensive content. The offensive content detecting means is configured to detect offensive information content in mobile communications between the user communication modules. The offensive information filtering enabling means includes means for filtering offensive content in communication with the offensive content detecting means. The offensive content filtering means is configured to filter the offensive information content detected in the mobile communications by the offensive content detecting means.

According to the fifth aspect, the offensive information filtering enabling means can include means for managing offensive content filtering policy. The offensive content filtering policy managing means can be configured to manage filtering policy used by the offensive content filtering means to filter the offensive information content detected in the mobile communications. For example, the offensive content filtering means can be configured to analyze the filtering policy associated with the user communication modules to determine whether offensive content filtering is enabled for the mobile communications. The offensive content filtering means can be configured to filter the offensive information content in the mobile communications when it is determined that offensive content filtering is enabled. The offensive content filtering policy managing means can be configured to manage offensive content filtering preferences of users.

According to the fifth aspect, the offensive information filtering enabling means can include means for storing information. The information storing means can be configured to store offensive content filtering information. For example, the information storing means can be configured to store a log of offensive information content. The offensive information filtering enabling means can include means for communicating. The communicating means can be configured to communicate information with user communication modules. The offensive content filtering means can be configured to remove the offensive information content from the mobile communications. The offensive content filtering means can be configured to block the mobile communications that include offensive information content. The offensive content filtering means can be configured to modify the offensive information content in the mobile communications to generate non-offensive information content. The system can include a system administration module in communication with the offensive information filtering enabling means. The system administration module can be configured to administer the offensive information filtering enabling means. According to an exemplary embodiment of the fifth aspect, the mobile communications can comprise, for example, rich media content, such as multimedia or other like information. Additionally or alternatively, the mobile communications can comprise, for example, service information, such as presence or other like information.

According to a sixth aspect of the present invention, a system for filtering presence information includes means for enabling offensive presence information filtering in communication with a plurality of user communication devices. The offensive presence information filtering enabling means includes means for recognizing offensive presence content. The offensive presence content recognizing means is configured to recognize offensive presence information content in communications between user communication devices. The offensive presence information filtering enabling means includes means for filtering offensive presence content in communication with the offensive presence content recognizing means. The offensive presence content filtering means is configured to filter the offensive presence information content detected in the communications by the offensive presence content recognizing means.

According to the sixth aspect, the offensive presence information filtering enabling means includes means for managing offensive presence content filtering policy. The offensive presence content filtering policy managing means can be configured to manage filtering policy used by the offensive presence content filtering means to filter the offensive presence information content detected in the communications. The offensive presence content filtering means can be configured to analyze the filtering policy associated with the user communication devices to determine whether offensive presence content filtering is enabled for the communications. The offensive presence content filtering means can be configured to filter the offensive presence information content in the communications when it is determined that offensive presence content filtering is enabled. The offensive presence content filtering policy managing means can be configured to manage offensive presence content filtering preferences of users.

According to the sixth aspect, the offensive presence information filtering enabling means can include means for repositing information. The information repositing means can be configured to store offensive presence content filtering information. The information repositing means can be configured to store a log of offensive presence information content. The offensive presence information filtering enabling means can include means for communicating. The communicating means can be configured to communicate information with user communication devices. The offensive presence content filtering means can be configured to remove the offensive presence information content from the communications. The offensive presence content filtering means can be configured to block the communications that include offensive presence information content. The offensive presence content filtering means can be configured to modify the offensive presence information content in the communications to generate non-offensive presence information content. The system can include a system administration module in communication with the offensive presence information filtering enabling means. The system administration module can be configured to administer the offensive presence information filtering enabling means.

According to a seventh aspect of the present invention, an apparatus for filtering offensive information content in a mobile communication environment includes a user communication device. The user communication device includes means for enabling offensive information filtering. The offensive information filtering enabling means includes means for detecting offensive content. The offensive content detecting means can be adapted to detect offensive information content in mobile communications between user communication devices. The offensive information filtering enabling means includes means for filtering offensive content in communication with the offensive content detecting means. The offensive content filtering means can be adapted to filter the offensive information content detected in the mobile communications by the offensive content detecting means.

According to the seventh aspect, the offensive information filtering enabling means can include means for managing offensive content filtering policy. The offensive content filtering policy managing means can be adapted to manage filtering policy used by the offensive content filtering means to filter the offensive information content detected in the mobile communications. The offensive content filtering means can be adapted to analyze the filtering policy associated with the user communication devices to determine whether offensive content filtering is enabled for the mobile communications. The offensive content filtering means can be adapted to filter the offensive information content in the mobile communications when it is determined that offensive content filtering is enabled. The offensive content filtering policy managing means can be adapted to manage offensive content filtering preferences of users.

According to the seventh aspect, the offensive information filtering enabling means can include means for storing information. The information storing means can be adapted to store offensive content filtering information. The information storing means can be adapted to store a log of offensive information content. The offensive information filtering enabling means can include means for communicating. The communicating means can be adapted to communicate information with user communication devices. The offensive content filtering means can be adapted to remove the offensive information content from the mobile communications. The offensive content filtering means can be adapted to block the mobile communications that include offensive information content. The offensive content filtering means can be adapted to modify the offensive information content in the mobile communications to generate non-offensive information content. A system administration server can be in communication with the offensive information filtering enabling means. The system administration server can be adapted to administer the offensive information filtering enabling means. According to an exemplary embodiment of the seventh aspect, the mobile communications can comprise, for example, rich media content, such as multimedia or other like information. Additionally or alternatively, the mobile communications can comprise, for example, service information, such as presence or other like information.

According to an eighth aspect of the present invention, a method of filtering presence information includes the steps of: communicating a message incorporating offensive presence content between user communication devices; recognizing the offensive presence content in the message; and filtering the offensive presence content from the message.

According to the eighth aspect, the method can include one or more of the following steps: generating the message incorporating the offensive presence content; managing offensive presence content filtering policy associated with each of the user communication devices; accessing offensive presence content filtering policy associated with the user communication devices; and analyzing the offensive presence content filtering policy associated with the user communication devices to determine whether offensive presence content filtering is enabled. The filtering step can be performed when it is determined that offensive presence content filtering is enabled. For example, the filtering step can include one or more of the following steps: removing the offensive presence content from the message; blocking the message when offensive presence content is recognized; and modifying the offensive presence content in the communication to generate non-offensive presence content. The method can also include one or more of the following steps: communicating the message with non-offensive presence content after the filtering step; managing offensive presence content filtering preferences of users; storing offensive presence content filtering information; and storing a log of offensive presence content recognized in the recognizing step.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for filtering information in a mobile communication system, in accordance with an exemplary embodiment of the present invention.

FIG. 2 is a flowchart illustrating steps for filtering presence information text, in accordance with an exemplary embodiment of the present invention.

FIG. 3 is a block diagram illustrating a system for filtering presence information, in accordance with an exemplary embodiment of the present invention.

FIG. 4 is a block diagram illustrating a system for filtering offensive content in a mobile communication environment, in accordance with an alternative exemplary embodiment of the present invention.

FIG. 5 is a flowchart illustrating steps for filtering offensive information content in a communication environment, in accordance with an exemplary embodiment of the present invention.

### DETAILED DESCRIPTION OF THE PREFERRED EMBODIMENTS

Exemplary embodiments of the present invention are directed to a system and method for filtering offensive information content in communication systems, including wireless and wired communication systems. According to one exemplary embodiment, the present invention can allow policy-based blocking or amending of offensive content of various types (e.g., abusive, pornographic, or the like) in communications that are handled by a rich-media delivery service. Such blocking or amending can include any and all suitable media types (e.g., text, audio, video, and the like), and pertains to content included in the messaging traffic itself, as well as to content found in accompanying service information (e.g., presence information, profile information, and the like). Thus, according to another exemplary embodiment, the present invention can also support filtering of offensive content in presence information. Exemplary embodiments of the present invention can provide a protected environment for presence-enhanced communication services, not only in terms of the media handled or transmitted by these services, but also for the presence enhancements themselves. Accordingly, the present invention can provide a safe environment for communication services using rich media and/or presence enhancements to allow users to safely communicate using such services.

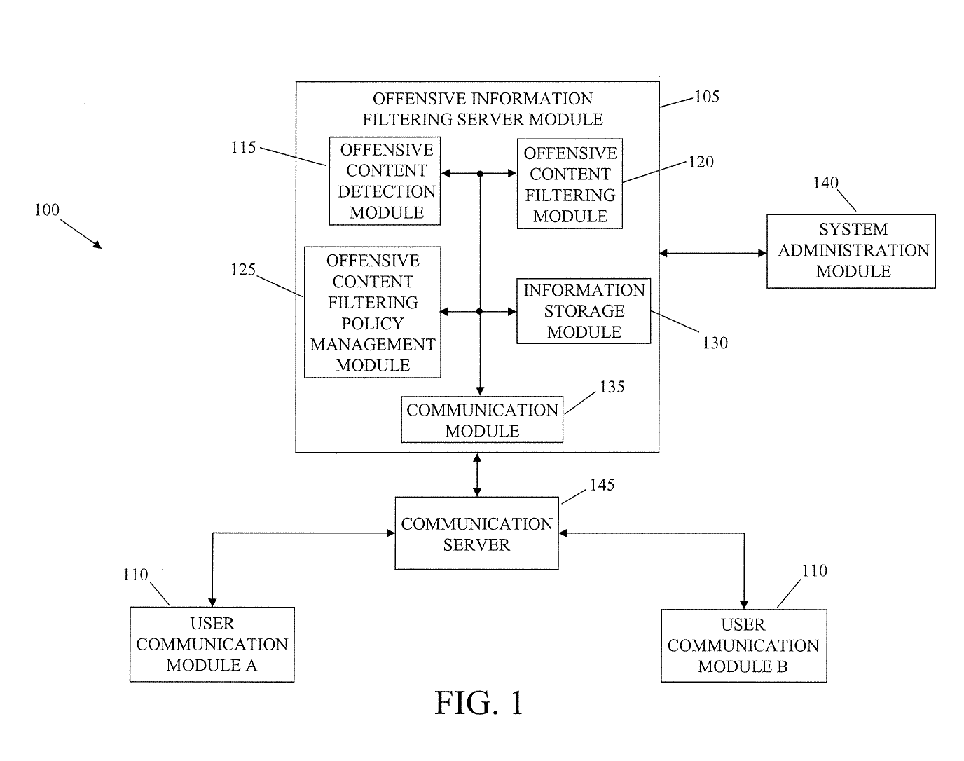

These and other aspects and embodiments of the present invention will now be described in greater detail. FIG. 1 is a block diagram illustrating a system 100 for filtering information in a communication system, in accordance with an exemplary embodiment of the present invention. The system 100 includes an offensive information filtering server module 105. The offensive information filtering server module 105 is in communication with a plurality of user communication modules 110. For purposes of illustration and not limitation, the offensive information filtering server module 105 can be in communication with a first user communication module A and a second user communication module B. However, any suitable number of user communication modules 110 (e.g., user communication module 1, user communication module 2, user communication module 3, . . . , user communication module N, where N is any appropriate number) can be used with the system 100 in accordance with exemplary embodiments of the present invention. Each user communication module 110 can comprise any suitable type of wireless or wired communication module or device that is capable of receiving and transmitting messages and other information using any appropriate type of communication service. For example, each of the user communication modules 110 can comprise a mobile or handheld device (e.g., cellular telephone, personal digital assistant (PDA)), a personal computer (PC), or other like communication endpoint.

The offensive information filtering server module 105 includes an offensive content detection module 115. The offensive content detection module 115 is configured to detect offensive information content in communications between user communication modules 110 (e.g., between user communication modules A and B). According to exemplary embodiments, the offensive information content can comprise any suitable type of textual, audio, graphical, multimedia, non-multimedia, rich content, non-rich content, presence, or other like information that is racist, defamatory, derogatory, obscene, scatological, indecent, pornographic, abusive, violent, or otherwise offensive, in that such information content violates social and/or moral standards of conduct and decency of a community. For example, the communication can comprise any suitable type of mobile or wireless message or other communication that (potentially) includes offensive content, and that can be wirelessly transmitted and received between the user communication modules 110. However, those of ordinary skill in the art will recognize that exemplary embodiments of the present invention can be used with any appropriate type of wireless or wired messaging or communication system (e.g., e-mail, instant messaging (IM), short message service (SMS), enhanced messaging service (EMS), multimedia messaging service (MMS), or the like). Thus, the communication can comprise any suitable type of wireless or wired message or other communication that may include offensive information content.

The offensive content detection module 115 can detect or otherwise recognize offensive information content in the communications using any suitable mechanism. For purposes of illustration and not limitation, for textual and/or graphical information, the offensive content detection module 115 can use any suitable type of text and/or pattern recognition algorithms or other like mechanisms known to those of ordinary skill in the art to detect text and/or graphical images, respectively, in the information content that are offensive. According to an exemplary embodiment, the offensive content detection module 115 can be configured to detect offensive content in any suitable type of rich media or presence information. For example, graphical, presentation, or other like clip media can contain text (e.g., title, embedded handwriting, comments, words, and the like). The text can be scanned by the offensive content detection module 115 for offensive material. Additionally, audio streams, voice data, and the like can be converted to text (e.g., via any suitable type of audio-to-text translation or transcription algorithm), and the offensive content detection module 115 can scan the text for offensive content. RSS feeds, pushed content, presence information, and the like can contain text attributes or snippets. The offensive content detection module 115 can scan such bits of text for offensive information content. The offensive content detection module 115 can also examine any suitable type of global or other repository for user or entity profiles, such as a public profile of a user, that can contain notes or other free text to locate any offensive information content. For addressing information, URIs, display names, and the like, the offensive content detection module 115 can scan any such information that is textual or that has associated text (e.g., friendly name to URI). Additionally, the offensive content detection module 115 can use black lists, dictionaries, or other like information sources to determine whether offensive information content is contained in (textual) presence information or the like.

Additionally, using suitable pattern recognition algorithms, any appropriate type of graphical, pictorial, video, clip, or presentation can be examined or otherwise analyzed for offensive content (e.g., violent or pornographic images). For example, if an image contains excessive flesh tones (e.g., by detecting human skin patterns in the image), and the percentage of such flesh tones relative to the total image is above a predetermined threshold, the offensive content detection module 115 can determine that the image contains offensive information content (e.g., potentially pornographic images). However, those of ordinary skill in the art will recognize that the nature and types of any such algorithm(s) used by the offensive content detection module 115 will depend on various factors, including, for example, the nature and types of information communicated between user communication modules 110 (e.g., whether textual, graphical, audio, multimedia, or the like, or some combination thereof), and other like factors.

According to one exemplary embodiment, the offensive content detection module 115 can include appropriate look-up tables that can be used to determine what (if any) information content in a communication is offensive. Such look-up tables can be stored in a suitable computer memory or other computer storage device internal to or in communication with the offensive content detection module 115 and/or the offensive information filtering server module 105. Such a look-up table can include a list of words or phrases that are considered offensive (e.g., by users, by operators, by service providers, or other entities). For example, when parsing or otherwise scanning communications, the offensive content detection module 115 can look up each parsed or scanned word or phrase in the look-up table to determine if such a word or phrase is in the list (and, therefore, considered offensive).

Such look-up tables can be used by the offensive content detection module 115 to maintain any and all offensive information content specifications for users of the system 100. For example, separate look-up tables can be maintained for each user communication module 110, a single look-up table can be maintained for all users that incorporates the particular offensive information content specified by each user, or a combination of both scenarios (e.g., a generic look-up table for all users, and individual look-up tables for each, any, or all users). Such lookup tables can be configured to maintain any suitable type and number of offensive information content specifications that are to be filtered by the offensive information filtering server module 105. The size of such a table will depend on, for example, the number of users of the system 100, the breadth of offensive information content to be filtered, and other like factors. Additionally, as skilled artisans will recognize, the nature and content of the offensive information content specifications contained in such a look-up table(s) will depend on, for example, the type and nature of communication services and platforms supported, operator policies and preferences, user policies and preferences, and other like factors.

Alternatively, suitable Boolean or other logic or rules can be used for detecting offensive information content in communications. For example, Boolean logic can be used to determine that IF an image contains greater than 75% human skin patterns, THEN the image is offensive (e.g., pornographic). Likewise, Boolean logic can be used to determine that IF a message contains the word “HELL,” THEN the message contains offensive information content (e.g., scatological). Likewise, Boolean logic can be used to determine that IF two (non-offensive) words are used together in a certain order in a phrase (e.g., “KILLING” and “MACHINE”), THEN the message contains offensive information content (e.g., violent). The complexity of such logic or rules will depend on the nature and type of the information content supported by the various communication systems and the system 100, as well as other like factors. More complex mechanisms, such as neural networks, can be adapted to dynamically “learn” how to detect offensive information content in communications. For example, according to an exemplary embodiment, the offensive content detection module 115 can “learn” that the word “HELL” is considered offensive. Such information can be fed back to the offensive content detection module 115 to allow such “learning” to take place and to refine these or other like offensive information content detection algorithms.

The offensive information filtering server module 105 includes an offensive content filtering module 120 in communication with the offensive content detection module 115. The offensive content filtering module 120 is configured to filter the offensive information content detected in the communications by the offensive content detection module 115. For example, upon detection of offensive information content in a communication, the offensive content detection module 115 can communicate a signal or other indication to the offensive content filtering module 120 that offensive information content has been detected in the communication, as well as the portion of the communication that is recognized as offensive (e.g., the particular words or phrases in the communication that are detected as offensive). For purposes of illustration and not limitation, user communication module A can transmit a message containing offensive information content (e.g., certain scatological words) as a communication to user communication module B. The offensive content detection module 115 detects the offensive information content in the message (e.g., by scanning the text of the message), and notifies the offensive content filtering module 120 that offensive information content has been detected, including an indication of the specific words in the message that are determined to be offensive.

The offensive content filtering module 120 can filter the offensive information content in any suitable manner. For example, the offensive content filtering module 120 can block the entire message to prevent the message from being communicated to user communication module B. Alternatively, the offensive content filtering module 120 can remove, gray out, or otherwise obscure the offensive words, while preserving the rest of the message. In other words, user communication module B would receive the message, but the message would be devoid of the offensive information content. For example, the offensive content filtering module 120 can remove the offensive content and replace it with an indication that the offensive information content has been filtered out (e.g., by replacing such offensive words or images with “<<FILTERED>>” or other like indication), or just simply delete the offending information from the message. Alternatively, the offensive content filtering module 120 can alter, modify, partially modify, or otherwise transform the offensive information content into non-offensive information content. For example, the offensive content filtering module 120 can modify the word “HELL” to read “HECK.” Additionally, pornographic or violent images can be replaced with images of bucolic scenery or other unoffending images. The nature and type of filtering performed by the offensive content filtering module 120 will depend on various factors, including, for example, the nature and type of information content that can be communicated via the system 100, the preferences and policies of users, operators, and service providers, as well as other like factors.

Each or any user of the system 100 can specify their offensive content filtering preferences for messages or other like information that are communicated to and from that user. Such preferences can be captured and maintained for each user in a corresponding offensive content filtering policy. The offensive content filtering policy of each user can specify any suitable type of preferences or settings for performing offensive content filtering, such as, for example, when such filtering is to be performed (e.g., for every message received, for only messages received from a certain user or users, when any message is sent), the type of filtering that is to occur (e.g., filter only text, do not filter audio, filter all information content), rules for filtering offensive information content (e.g., block any communication with detected offensive information content, remove offensive information content from messages), and other like policies and preferences. Such offensive content filtering policies can be used by the offensive content filtering module 120 to determine when and how offensive words, phrases, images, and other information content in the communications are to be filtered. For example, a parent could specify an offensive content filtering policy that any messages to their child that contain sexually-suggestive words or phrases are to be blocked entirely. Additionally, a user could specify that an offensive content filtering policy that any communications that include violent images are to have those images replaced with an image of a flower. Another user could specify an offensive content filtering policy that any messages from a particular individual that contain offensive words or phrases are to have those words and phrases deleted before forwarding the message to the user. Other users may specify that no offensive content filtering is to be performed on any messages. Thus, the offensive content filtering module 120 can be configured to analyze or otherwise examine the offensive content filtering policy associated with the users and/or user communication modules 110 to determine whether offensive content filtering is enabled when communicating a message, how such offensive information content filtering is to be performed, and to what extent.

For example, the user of user communication module A (i.e., user A) may desire to send a message incorporating offensive information content to the user of user communication module B (i.e., user B). The offensive content filtering module 120 can examine the offensive content filtering policy associated with each of user communication modules A and B to determine whether offensive content filtering is to be performed. For example, the offensive content filtering policy associated with user communication module A can specify that offensive content filtering is not to be performed when messages are sent. However, the offensive content filtering policy associated with user communication module B can specify that offensive content filtering is to be performed on all received messages (and the offensive information content is to be removed from the messages). Thus, the offensive content filtering module 120 can be configured to filter the offensive information content in the communications when it is determined that offensive content filtering is enabled.

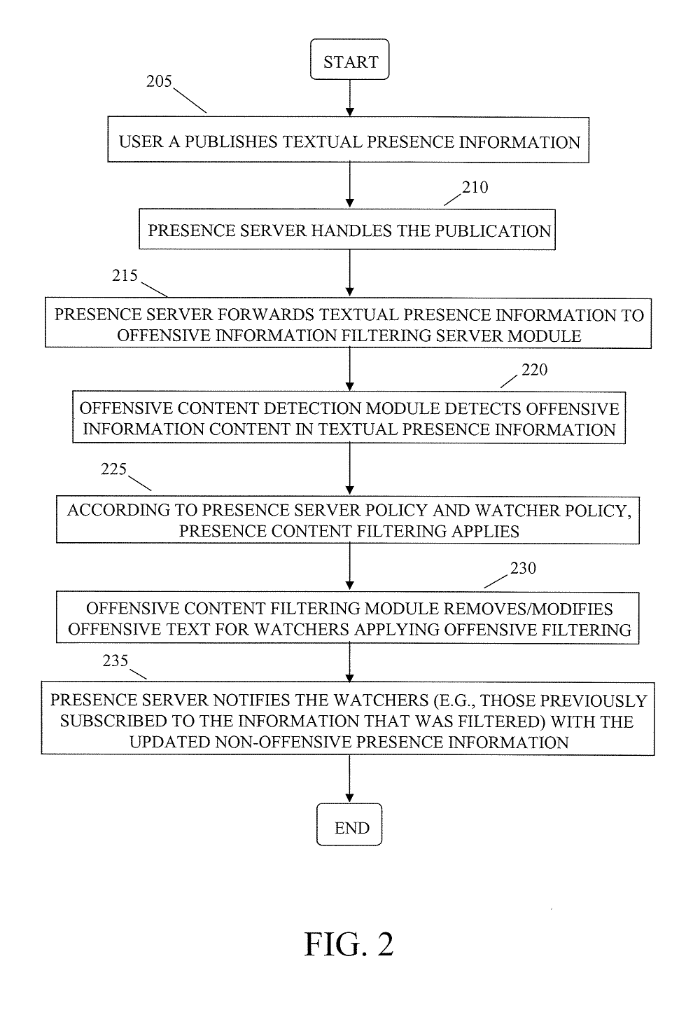

For example, user-entered presence information (e.g., a user status entry, manually-entered user location, availability, or other like information) can contain offensive wording that notified users (e.g., contacts for the presence-enhanced communication service) would receive. Exemplary embodiments of the present invention can recognize and filter the presence information to remove or modify such offensive wording. Such a scenario is depicted in FIG. 2, which is a flowchart illustrating steps for filtering presence information text, in accordance with an exemplary embodiment of the present invention. In step 205, user A publishes textual presence information. User B has subscribed to the presence information of user A (i.e., user B is a “watcher”). Since user B is subscribed to the presence information of user A, user B will receive notifications on presence information changes without initiating any form of communication. In step 210, a presence server handles the publication. In step 215, the presence server forwards the textual presence information to the offensive information filtering server module 105. In step 220, the offensive content detection module 115 detects offensive information content in the text presence information. In step 225, the offensive content filtering module 120 examines offensive content filter policy for user B (and the presence server, if necessary) to determine whether filtering should be performed. For purposes of the present illustration, according to offensive content filtering policy specified by user B, presence content filtering is to be performed. Accordingly, in step 230, the offensive content filtering module 120 removes and/or modifies the offensive text (e.g., depending on the policy specified by user B) for those watchers to which offensive filtering applies (e.g., user B). In other words, since the offensive content filtering policy associated with user B specifies that filtering is to be performed, the offensive content filtering module 120 can perform the filtering of the offensive information content in the presence information before user B is notified of the presence information published by user A. In step 235, the presence server notifies the watchers (e.g., those previously subscribed to the information that was filtered, such as user B) with the updated non-offensive presence information.

There may be situations in which the filtering of offensive information content from a communication results in no content being left in the communication. In other words, filtering the offensive information content in a communication may remove all information contained in that communication. For example, in the previous illustration, the offensive content filtering policy associated with user B can specify that any offensive information content is to be removed (as opposed to modified) in communications before being received by user B. Applying such an offensive content filtering policy to the presence information could result in no presence information remaining for transmission to user B (i.e., all of the presence information was deemed offensive, and, therefore, removed). In such situations, the offensive content filtering module 120 can provide an appropriate indication or other notification to user B (and user A, if so desired) that a communication from user A was attempted, but filtering resulted in the entire contents of the message being removed. Otherwise, the blank communication can be forwarded to user B after filtering (e.g., a filtered e-mail that contains no information in the body of the message). The manner in which users receive such completely-filtered communications can be specified by each user through appropriate settings or preferences. For example, the user can specify that completely-filtered communications are to blocked, and/or a notification of such complete filtering is to be forwarded in place of the communication. Other such preferences or settings can be established according to each user's communication and filtering requirements, needs, and desires.

Exemplary embodiments of the present invention can prevent offensive information content from being delivered to those users (e.g., watchers, such as user B) to which such filtering is applied. Such a filtering configuration can be per user (e.g., per watcher), so that offensive presence content can reach some watchers that do not desire such filtering, yet be removed or modified for other watchers as part of those watchers' policies or preferences. According to the present exemplary embodiment, such presence content filtering can be applied to any suitable presence information source, such as, for example, presence applications and services, network elements, and other like sources that can provide presence information.

To manage the offensive content filtering policy associated with users and/or user communication modules 110, the offensive information filtering server module 105 can include a offensive content filtering policy management module 125. The offensive content filtering policy management module 125 can be in communication with the offensive content detection module 115 and the offensive content filtering module 120. The offensive content filtering policy management module 125 can be configured to manage the offensive content filtering policy and preferences, associated with each user and/or each of the user communication modules 110 (e.g., user communication modules A and B), that are used by the offensive content filtering module 120 to filter the offensive information content detected in the communications. For example, the offensive content filtering policy management module 125 can be configured to manage the offensive content filtering preferences of users. For purposes of illustration and not limitation, a user can specify an offensive content filtering policy that applies to any and all communication devices used by that user. Additionally or alternatively, an offensive content filtering policy can be applied to a particular communication device (e.g., a PC located in a home), regardless of what user is using that device.

A separate offensive content filtering policy record can be maintained for each user and/or user communication module 110 by the offensive content filtering policy management module 125, either as separate files or as part of a single, comprehensive offensive content filtering policy applicable to all users. The offensive content filtering policy can be created, modified, and updated by the user at any appropriate time by suitably interacting with the offensive content filtering policy management module 125 (e.g., via an appropriate graphical and/or textual interface, by sending commands or requests to the offensive information filtering server module 105, specifying preferences in a policy document that is forwarded to the offensive information filtering server module 105, or other like interactive mechanisms). The offensive content filtering policy management module 125 can maintain and manage any suitable type of preferences, rules, policies, account settings, or other profile information for each user and/or user communication module 110.

The offensive content filtering policy management module 125 can also be used to manage offensive content filtering policy and preferences from other entities that use or are otherwise associated with the system 100, such as one or more communication service operators. Such operators can establish appropriate preferences or policies that are applicable to individual users or groups of users, all of which can be managed and maintained according to exemplary embodiments. For example, a particular operator (e.g., the communication service operator providing communication services to user communication module A) can establish a preference or policy that any messages incorporating offensive content (e.g., obscene words or phrases) that are transmitted from users in the operator's network to users in a particular remote operator network are to be filtered so as to remove any such offensive content.

The offensive information filtering server module 105 can include an information storage module 130 that can be in communication with any or all of the offensive content detection module 115, the offensive content filtering module 120, and the offensive content filtering policy management module 125. The information storage module 130 can be configured to store offensive content filtering information. For example, the information storage module 130 can store the offensive content filtering policies, preferences, and other settings and profiles specified by the users. For example, the offensive content filtering policy management module 125 can store offensive content filtering policies in the information storage module 130, and the offensive content filtering module 120 can access or otherwise retrieve such policies and other preference information when performing offensive content filtering. Additionally, the information storage module 130 can store a log of offensive information content detected and filtered by the offensive information filtering server module 105. Such logged information can be used to track such occurrences for legal and other uses. Furthermore, the information storage module 130 can store the look-up tables or other information sources (e.g., black lists, dictionaries, or the like) that can be used by the offensive content detection module 115 to detect and recognize offensive information content. The information storage module 130 can also store content transforms or other algorithms or processes that can be used by the offensive content filtering module 120 to filter offensive information content in the communications. However, the information storage module 130 can be used to store any suitable type of information used or maintained by the offensive information filtering server module 105 and the system 100. The information storage module 130 can be comprised of any suitable type of computer-readable or other computer storage medium capable of storing information in electrical, electronic, or any other suitable form.

The offensive information filtering server module 105 can include a communication module 135. The communication module 135 is configured to communicate information with the users (e.g., messages (filtered or not), offensive content filtering policy or other preference information, and the like). However, each of the modules of the offensive information filtering server module 105 can use the communication module 135 to communicate any suitable type of information to, for example, users, operators, and other entities in communication with the system 100. The communication module 130 can be adapted to use any suitable type of wireless or wired communication link, connection, or medium that uses an appropriate form of wireless or wired communication mechanism, protocol, or technique, or any suitable combination thereof, to communicate with the various entities of the system 100. In other words, the communication module 135 can be configured to use any or all of a plurality of communication access protocols to support various suitable types of networks, security settings, communication environments, and the like.

The system 100 can include a system administration module 140 in communication with the offensive information filtering server module 105 (e.g., via the communication module 135). The system administration module 140 can be configured to administer or otherwise manage the offensive information filtering server module 105 (or any of the modules thereof). The system administration module 140 can be used by, for example, a service provider, a system administrator, operator, or the like to manage and maintain any or all aspects of the offensive information filtering server module 105, such as, for example, managing offensive content filtering preferences of the operator or service provider (e.g., via the offensive content filtering policy management module 125).

The system 100 can include suitable additional modules or components as necessary to assist or augment the functionality of any or all of the modules of the system 100. For example, each communication service operator or provider can include one or more suitable communication servers 145. Each communication server 145 can be in communication with the offensive information filtering server module 105, with respective user communication modules 110 (within the operator network), and with each other (and other like modules) to facilitate communication transactions throughout the system 100. The communication servers 145 and corresponding operator networks can be operated or otherwise managed by any appropriate type of network operator, including, but not limited to, a Mobile Network Operator (MNO), a mobile virtual network operator, a wireless service provider, a wireless carrier, a mobile phone operator, a cellular company or organization, a fixed network operator, a converged network operator, or any suitable combination thereof. According to an alternative exemplary embodiment, any or all of the functionality of the offensive information filtering server module 105 can reside in the communication server 145, or be distributed between the two components.

For purposes of illustration and not limitation, both user communication modules A and B are in communication with the communication server 145 that is in communication with the offensive information filtering server module 105. However, the system 100 can support any suitable number of such communication servers 145. For example, user communication module A can be in communication with a communication server A that is in communication with the offensive information filtering server module 105 (e.g., via any suitable type of wireless or wired communication network). User communication module B can be in communication with a communication server B that is in communication with the offensive information filtering server module 105 (e.g., via a wireless or wired network). Those communication servers A and B can also be in communication with each other (e.g., via the same network) to facilitate communication between user communication modules A and B. Such communication servers 145 can forward the messages or other communications to the offensive information filtering server module 105 for appropriate offensive content detection and filtering. The number and type of such communication servers 145 will depend on the number and type of communication services offered in each operator network. For example, each communication server can comprise a suitable type of service enabler, such as, for example, a presence server, an IM Service Center (e.g., an IM enabler), a Short Message Service Center (SMSC), a gaming or other application server, or the like.

Additionally or alternatively, the system 100 can include additional database or storage modules that can be internal to or communication with the offensive information filtering server module 105. Such storage modules can be configured to store any suitable type of information generated or used by or with the system 100. The storage modules can be comprised of any suitable type of computer-readable or other computer storage medium capable of storing information in electrical, electronic, or any other suitable form.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the offensive information filtering server module 105 (including the offensive content detection module 115, the offensive content filtering module 120, the offensive content filtering policy management module 125, the information storage module 130, and the communication module 135) can be located extraterritorially to the United States (e.g., in Canada and/or in one or more other foreign countries). However, the user communication devices 110 can be located within the United States, such that the control of the system 100 as a whole is exercised and beneficial use of the system 100 is obtained by the user within the United States.

Each of modules of the system 100, including the offensive information filtering server module 105 (including the offensive content detection module 115, the offensive content filtering module 120, the offensive content filtering policy management module 125, the information storage module 130, and the communication module 135), and the user communication modules 110, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the system 100 can be comprised of any combination of hardware, firmware and software that is capable of performing the functions associated with the respective module.

Alternatively, each, any, or all of the components of the system 100 (including the offensive information filtering server module 105 and the user communication modules 110) can be comprised of one or more microprocessors and associated memory(ies) that store the steps of a computer program to perform the functions of one or more of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the system 100. For example, the actual source code or object code of the computer program or other like structure can be stored in the memory.

Alternative architectures or structures can be used to implement the various functions of the system 100 as described herein. For example, functions from two or more modules can be implemented in a single module, or functions from one module can be distributed among several different modules. For purposes of illustration and not limitation, the offensive content filtering policy management module 125 can form a component of the offensive content filtering module 120, such that the offensive content filtering module 120 is configured to perform the functionality of that (incorporated) module. As discussed previously, any or all of the functionality of the offensive information filtering server module 105 can be incorporated into or otherwise form a part of the communication server 145, or be suitably distributed between such components.

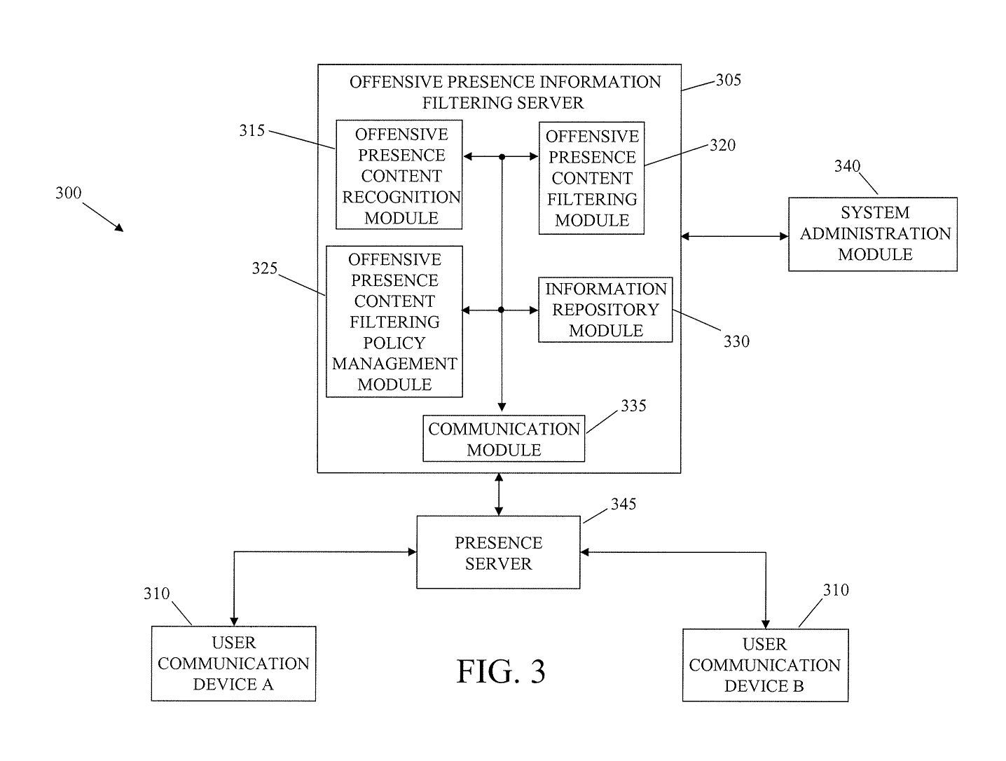

The offensive information filtering server module 105 can be used to filter offensive information content from, for example, rich media and presence information sources. However, the offensive information filtering server module 105 can be tailored to filter offensive information content from a particular type of content. For example, FIG. 3 is a block diagram illustrating a system 300 for filtering presence information, in accordance with an exemplary embodiment of the present invention. The system 300 includes an offensive presence information filtering server 305 in communication with a plurality of user communication devices 310. The offensive presence information filtering server 305 includes an offensive presence content recognition module 315. The offensive presence content recognition module 315 is configured to recognize offensive presence information content in communications between user communication devices 310 (e.g., in a manner similar to that described previously for the offensive content detection module 115).

The offensive presence information filtering server 305 includes an offensive presence content filtering module 320 in communication with the offensive presence content recognition module 315. The offensive presence content filtering module 320 is configured to filter the offensive presence information content detected in the communications by the offensive presence content recognition module 315 (e.g., in a manner similar to that described previously for the offensive content filtering module 120). For example, the offensive presence content filtering module 320 can be configured to remove the offensive presence information content from the communications. Alternatively, the offensive presence content filtering module 320 can be configured to block the communications that include offensive presence information content. The offensive presence content filtering module 320 can also be configured to modify the offensive presence information content in the communications to generate non-offensive presence information content.

The offensive presence information filtering server 305 can include an offensive presence content filtering policy management module 325 that can be in communication with the offensive presence content recognition module 315 and the offensive presence content filtering module 320. The offensive presence content filtering policy management module 325 can be configured to manage filtering policy used by the offensive presence content filtering module 320 to filter the offensive presence information content detected in the communications (e.g., in a manner similar to that described previously for the offensive content filtering policy management module 125). The offensive presence content filtering policy management module 325 can also be configured to manage offensive presence content filtering preferences of users and other entities who use and interact with the system 300.

According to the present alternative exemplary embodiment, the offensive presence content filtering module 320 can be configured to analyze the filtering policy associated with the user communication devices 310 to determine whether offensive presence content filtering is enabled for the communications, as discussed previously. The offensive presence content filtering module 320 can also be configured to filter the offensive presence information content in the communications when it is determined that offensive presence content filtering is enabled, in the manner described above.

The offensive presence information filtering server 305 can include an information repository module 330. The information repository module 330 can be configured to store offensive presence content filtering information (e.g., in a manner similar to that described previously for the information storage module 130). For example, the information repository module 330 can be configured to store a log of offensive presence information content, as well as black lists, dictionaries, and other information sources that can be used by, for example, the offensive presence content recognition module 315. However, any or all of the modules of the offensive presence information filtering server 305 can use the information repository module 330 to store any suitable type of information used by or otherwise associated with the system 300.

The offensive presence information filtering server 305 can also include a communication module 335. The communication module 335 can be configured to communicate information with user communication devices 310 (e.g., in a manner similar to that described previously for the communication module 135). Any or all of the modules of the offensive presence information filtering server 305 can use the communication module 335 to communicate any suitable type of information used by or otherwise associated with the system 300. The system 300 can also include a system administration module 340 in communication with the offensive presence information filtering server 305. The system administration module 340 can be configured to administer the offensive presence information filtering server 305 (e.g., in a manner similar to that described previously for the system administration module 140).

The system 300 can include suitable additional modules or components as necessary to assist or augment the functionality of any or all of the modules of the system 300. For example, each communication service operator or provider can include one or more suitable presence servers 345. Each presence server 345 can be in communication with the offensive presence information filtering server 305 (e.g., via the communication module 335), with respective user communication devices 310 (within the operator network), and with each other (and other like modules) to facilitate communication transactions throughout the system 300. According to an alternative exemplary embodiment, any or all of the functionality of the offensive presence information filtering server 305 can reside in the presence server 345, or be suitably distributed between such components.

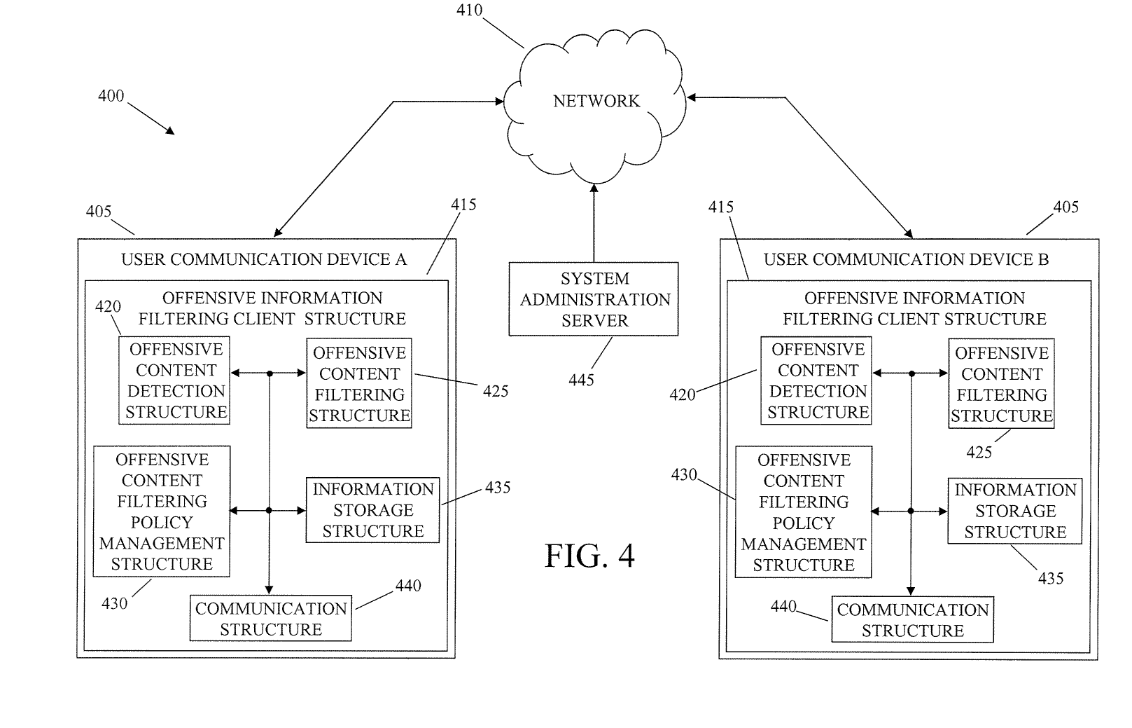

The exemplary and alternative exemplary embodiments illustrated in FIGS. 1 and 3 can provide centralized, server-side offensive information content filtering. Alternatively, the offensive information content filtering described herein can be performed on the client-side so as to distribute the functionality throughout the system. For purposes of illustration and not limitation, FIG. 4 is a block diagram illustrating a system 400 for filtering offensive content in a communication environment, in accordance with an alternative exemplary embodiment of the present invention.

The system 400 includes one or more user communication devices 405 (e.g., user communication device A and user communication device B, although the system 400 can support any suitable number of such user communication devices 305). For example, first user communication device A can be adapted to communicate a message (potentially) incorporating offensive information content to a second user communication device B via the network 410. The network 410 can comprise, and the system 400 can be used with, any suitable type of wireless and/or wired communication network that supports rich media and/or presence information delivery. The network 410 can be operated or otherwise managed by any appropriate type of network operator, including, but not limited to, a MNO, a mobile virtual network operator, a wireless service provider, a wireless carrier, a mobile phone operator, a cellular company or organization, a fixed network operator, a converged network operator, or any suitable combination thereof. Although one network 410 is illustrated in FIG. 4, skilled artisans will recognize that any suitable number (e.g., network 1, network 2, network 3, . . . , network M, where M is any appropriate number) and kinds (e.g., wired, wireless, or combination thereof) of networks 410 can be used with system 400 in accordance with exemplary embodiments. The network 410 can support or otherwise provide any suitable type of messaging or communication service or system (e.g., e-mail, IM, SMS, EMS, MMS, or the like), and all such services and systems can be configured to utilize the offensive information content filtering system 400 of the present invention. Each user communication device 405 can belong to the same or different network 410 as any other user communication device 405. For example, user communication module A can belong to or otherwise be associated with the same or different network 410 and network operator as user communication module B.

Each user communication device 405 includes offensive information filtering client structure 415. The offensive information filtering client structure 415 can comprise, for example, a suitable client application adapted to execute on the user communication device 405. According to an exemplary embodiment, such a client application can comprise the operating system software for running and operating the user communication device 405. Other applications or modules can be configured to run within such an operating system environment to provide other various and suitable features and functionality for the user communication device 405. According to an alternative exemplary embodiment, the client application can comprise an application or other software that runs within an operating system that is provided by and with the user communication device 405. In such an alternative exemplary embodiment, the offensive information filtering client structure 415 can comprise one or a collection of application modules that provide the functionality described herein, in addition to other application modules that may be running or otherwise executing within the operating system environment provided by or with the user communication device 405. The actual implementation of the offensive information filtering client structure 415 will depend on the type of user communication device 405 and the functionality and features of such a device, and other like factors.

The offensive information filtering client structure 415 includes offensive content detection structure 420. The offensive content detection structure 420 is adapted to detect offensive information content in communications between user communication devices 405 (e.g., in a manner similar to that described previously for the offensive content detection module 115). The offensive information filtering client structure 415 also includes offensive content filtering structure 425 in communication with the offensive content detection structure 420. The offensive content filtering structure 425 is adapted to filter the offensive information content detected in the communications by the offensive content detection structure 420 (e.g., in a manner similar to that described previously for the offensive content filtering module 120). For example, the offensive content filtering structure 425 can be adapted to remove the offensive information content from the communications. Alternatively, the offensive content filtering structure 425 can be adapted to block the communications that include offensive information content. The offensive content filtering structure 425 can also be adapted to modify the offensive information content in the communications to generate non-offensive information content.

The offensive information filtering client structure 415 can include offensive content filtering policy management structure 430. The offensive content filtering policy management structure 430 can be in communication with the offensive content filtering structure 425 and the offensive content detection structure 420. The offensive content filtering policy management structure 430 can be adapted to manage filtering policy used by the offensive content filtering structure 425 to filter the offensive information content detected in the communications (e.g., in a manner similar to that described previously for the offensive content filtering policy management module 125). For example, the offensive content filtering policy management structure 430 can be adapted to manage offensive content filtering preferences of users. In particular, the offensive content filtering structure 425 can be adapted to analyze the filtering policy associated with the user communication devices 405 to determine whether offensive content filtering is enabled for the communications. The offensive content filtering structure 425 can also be adapted to filter the offensive information content in the communications when it is determined that offensive content filtering is enabled, in the manner described previously.

The offensive information filtering client structure 415 can include information storage structure 435. The information storage structure 435 can be adapted to store offensive content filtering information (e.g., in a manner similar to that described previously for the information storage module 130). Any or all of the components of the offensive information filtering client structure 415 can use the information storage structure 435 to store any suitable type of information used by or otherwise associated with the respective user communication device 405 and the system 400. For example, the information storage structure 435 can be adapted to store a log of offensive information content. Additionally, the offensive content filtering policy management structure 430 can store offensive content filtering policy and preferences associated with the user communication device 405, and the offensive content filtering structure 425 can access or otherwise retrieve such policies and other preference information when performing offensive content information filtering. The information storage structure 435 can be comprised of any suitable type of computer-readable or other computer storage medium capable of storing information in electrical, electronic, or any other suitable form.

The offensive information filtering structure 415 can include communication structure 440. The communication structure 440 can be adapted to communicate information to other user communication devices 405 (e.g., in a manner similar to that described previously for the communication module 135). Each of the components of the offensive information filtering client structure 415 can use the communication structure 440 to communicate any suitable type of information to, for example, users, operators, and other entities using or otherwise in communication with the system 400. The communication structure 440 can be adapted to use any suitable type of wireless or wired communication link, connection, or medium that uses an appropriate form of wireless or wired communication mechanism, protocol, or technique, or any suitable combination thereof, to communicate with the various entities of the system 400. In other words, the communication structure 435 can be adapted to use any or all of a plurality of communication access protocols to support various suitable types of networks, security settings, communication environments, and the like.

The system 400 can include suitable additional modules or components as necessary to assist or augment the functionality of the offensive information filtering client structure 415 of each user communication device 405. For example, the system 400 can include one or more communication servers in communication with each other (e.g., via network 410). For example, each communication server can be in communication with one or more user communication devices 405. For example, a communication server A can be in communication with user communication device A, and a communication server B can be in communication with user communication device B. Such communication servers can be used for facilitating communication transactions between user communication devices 405.

The system 400 can also include a system administration server 445 in communication with the offensive information filtering client structure 415 of each user communication device 405 (e.g., via network 410). The system administration server 445 can be adapted to administer the offensive information filtering client structure 415 associated with each user communication device 405 (e.g., in a manner similar to that described previously for the system administration module 140). However, the system administration server 445 can be used to manage any and all appropriate aspects of the system 400.

Other alternative architectures or structures can be used to implement the various functions of the systems 100, 300, and 400 as described herein. For example, the offensive information filtering client structure 415 of the user communication devices 405 can instead reside in the respective communication servers 445. Alternatively, the offensive content filtering functionality can be distributed between a central server or component (e.g., the offensive information filtering server module 105 illustrated in FIG. 1) and the user communication devices (e.g., the user communication devices 405 illustrated in FIG. 4) and/or suitable communication servers. As discussed previously, the functionality of the offensive information filtering server module 105 can be incorporated into or otherwise form a part of the communication server 145 illustrated in FIG. 1. Additionally, the functionality of the offensive presence information filtering server 305 can be incorporated into or otherwise form a part of the presence server 345 illustrated in FIG. 3.

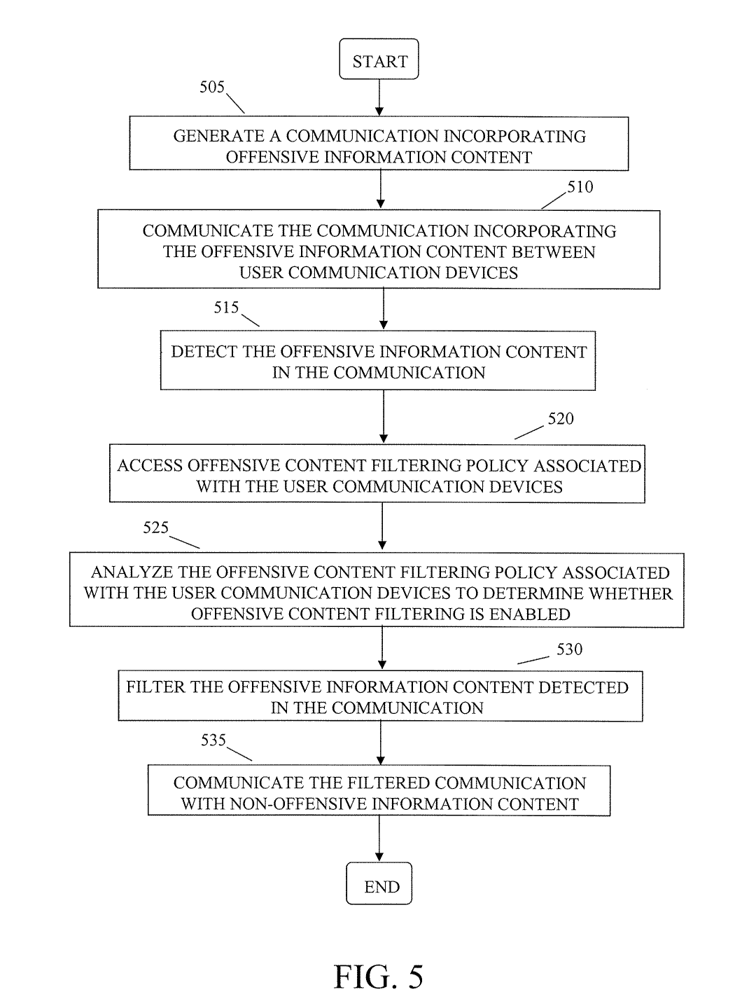

FIG. 5 is a flowchart illustrating steps for filtering offensive information content in a communication environment, in accordance with an exemplary embodiment of the present invention. The present method can be used in either wireless or wired communication systems that support rich media and/or presence information delivery. In step 505, a communication is generated that incorporates offensive information content. In step 510, the communication incorporating the offensive information content is communicated between user communication devices. In step 515, the offensive information content is detected in the communication. It is noted that if no offensive information content is detected, then the communication can be forwarded without modification. In step 520, offensive content filtering policy associated with the user communication devices is accessed. In step 525, the offensive content filtering policy associated with the user communication devices is analyzed to determine whether offensive content filtering is enabled. If offensive content filtering is not enabled for either or both user communication devices, then no such filtering is performed and the communication can be forwarded without modification.

However, if offensive content filtering is enabled for either or both of the user communication devices, then in step 530, the offensive information content detected in the communication is filtered. For example, the filtering step 530 can include the step of removing the offensive information content from the communication. Alternatively, the filtering step 530 can include the step of blocking the communication when offensive information content is detected. The filtering step 530 can alternatively include the step of modifying the offensive information content in the communication to generate non-offensive information content. Once the offensive information content in the communication is filtered (and the offensive content filtering policy associated with either user communication device does not specify that communications with offensive information content are to be blocked), then in step 535, the communication with non-offensive information content (i.e., the offensive information content either removed or modified) is communicated.

According to an alternative exemplary embodiment, the offensive content filtering policy associated with the user communication devices can be accessed before any detection of the offensive information content is performed. Consequently, if neither user communication device requires or desires offensive information content filtering, then neither the detecting nor the filtering steps need be performed, and the communication can be forwarded without any modification. Additionally, the method can also include one or more of the following steps: managing offensive content filtering policy associated with each of the user communication devices; managing offensive content filtering preferences of users; storing offensive content filtering information; and storing a log of offensive information content.

Each, all or any combination of the steps of a computer program as illustrated, for example, in FIG. 5 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any wireless or wired device, system or process for communicating information. For example, exemplary embodiments can be used in presence- and IM-based communication systems, such as in mobile and fixed IM systems and the like, and/or communication systems that support rich media content delivery to ensure a safe environment for users of such communication services.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for filtering information in a mobile communication system, comprising:
an offensive information filtering server module in communication with a plurality of user communication modules,
wherein the offensive information filtering server module comprises:
an offensive content detection module,
wherein the offensive content detection module is configured to detect offensive information content in mobile communications between the user communication modules; and
an offensive content filtering module in communication with the offensive content detection module,
wherein the offensive content filtering module is configured to filter the offensive information content detected in the mobile communications by the offensive content detection module.

2. The system of claim 1, wherein the offensive information filtering server module comprises:
an offensive content filtering policy management module,
wherein the offensive content filtering policy management module is configured to manage filtering policy used by the offensive content filtering module to filter the offensive information content detected in the mobile communications.

3. The system of claim 2, wherein the offensive content filtering policy management module is configured to manage offensive content filtering preferences of users.

4. The system of claim 1, wherein the offensive information filtering server module comprises:
an information storage module,
wherein the information storage module is configured to store offensive content filtering information.

5. The system of claim 4, wherein the information storage module is configured to store a log of offensive information content.

6. The system of claim 1, wherein the offensive information filtering server module comprises:
a communication module,
wherein the communication module is configured to communicate information with user communication modules.

7. A system for filtering presence information, comprising:
an offensive presence information filtering server in communication with a plurality of user communication devices,
wherein the offensive presence information filtering server comprises:
an offensive presence content recognition module,
wherein the offensive presence content recognition module is configured to recognize offensive presence information content in communications between user communication devices; and
an offensive presence content filtering module in communication with the offensive presence content recognition module,
wherein the offensive presence content filtering module is configured to filter the offensive presence information content detected in the communications by the offensive presence content recognition module.

8. The system of claim 7, wherein the offensive presence information filtering server comprises:
an offensive presence content filtering policy management module,
wherein the offensive presence content filtering policy management module is configured to manage filtering policy used by the offensive presence content filtering module to filter the offensive presence information content detected in the communications.

9. The system of claim 8, wherein the offensive presence content filtering policy management module is configured to manage offensive presence content filtering preferences of users.

10. The system of claim 7, wherein the offensive presence information filtering server comprises:
an information repository module,
wherein the information repository module is configured to store offensive presence content filtering information.

11. The system of claim 7, wherein the offensive presence information filtering server comprises:
a communication module,
wherein the communication module is configured to communicate information with user communication devices.

12. A method of filtering offensive information content in a communication environment, comprising the steps of:
a.) communicating a mobile communication incorporating offensive information content between user communication devices;
b.) detecting the offensive information content in the mobile communication; and
c.) filtering the offensive information content detected in the mobile communication.

13. The method of claim 12, comprising the step of:
d.) managing offensive content filtering policy associated with each of the user communication devices.

14. The method of claim 12, comprising the step of:
d.) accessing offensive content filtering policy associated with the user communication devices.

15. The method of claim 14, comprising the step of:
d.) analyzing the offensive content filtering policy associated with the user communication devices to determine whether offensive content filtering is enabled.

16. The method of claim 12, wherein step (c) comprises the step of:
d.) removing the offensive information content from the mobile communication.

17. The method of claim 12, wherein step (c) comprises the step of:
d.) blocking the mobile communication when offensive information content is detected.

18. The method of claim 12, wherein step (c) comprises the step of:
d.) modifying the offensive information content in the mobile communication to generate non-offensive information content.

19. The method of claim 12, comprising the step of:
d.) communicating the mobile communication with non-offensive information content after step (c).

20. The method of claim 12, comprising the step of:
d.) managing offensive content filtering preferences of users.

21. The method of claim 12, comprising the step of:
e.) storing a log of offensive information content.

22. A method of filtering presence information, comprising the steps of:
a.) communicating a message incorporating offensive presence content between user communication devices;
b.) recognizing the offensive presence content in the message; and
c.) filtering the offensive presence content from the message.

23. The method of claim 22, wherein step (c) comprises the step of:
d.) blocking the message when offensive presence content is recognized.

24. The method of claim 22, wherein step (c) comprises the step of:
d.) modifying the offensive presence content in the communication to generate non-offensive presence content.

25. The method of claim 22, comprising the step of:
d.) communicating the message with non-offensive presence content after step (c).
